(19) United States
(12) Patent Application Publication
(10) Pub. No.: US 2004/0008222 A1
(43) Pub. Date: Jan. 15, 2004

(54) User intuitive easy access computer system

(75) Inventors: Edward J. Hovatter, Moorestown, NJ (US); Claire A. King, Philadelphia, PA (US)

Correspondence Address: VOLPE AND KOENIG, P.C., UNITED PLAZA, SUITE 1600, 30 SOUTH 17TH STREET, PHILADELPHIA, PA, 19103, US

(73) Assignee: Silverlynk, Corporation, Moorestown, NJ

(21) Appl. No.: 10/191,602

(22) Filed: Jul. 9, 2002

(51) Int. Cl. G09G 5/00

(52) U.S. Cl. 345/749; 345/806

(57) ABSTRACT

The invention has several aspects. One aspect of the invention is hardware for a easy access computer system. The hardware includes touch screens or touch screen adapters for ease of hardware use. Also, to allow handwriting instead of typing, a graphical tablet is provided. Other aspects of the invention relate to software and their graphical user interfaces (GUIs). The GUIs in one aspect of the invention are limited to a specified number of oversized buttons. The oversized buttons have visible and verbal clues to their use. Preferably, the GUIs do not use scroll bars. Textual information in various applications is turned to audible speech in various software applications. A magnifier button allows for magnification of images on various GUIs. Another aspect of the invention is a search engine which filters web sites based on their easy access.

### BACKGROUND

This invention generally relates to computer systems. In particular, the invention relates to intuitive software and easy access hardware for computer systems.

Computer systems have reached great popularity over the years. Certain individuals, such as seniors, those with infirmities, disabilities, or others, have been reluctant or unable to use present computer systems. These systems require a certain level of manual dexterity and vision to operate. To illustrate, a user desires to use an application. The user typically “double clicks” an icon to execute the application. Although the required speed between clicks of a “double click” can be relaxed, it is still difficult for less dexterous individuals to execute this maneuver. Additionally, on a monitor, in particular a 14 inch (36 centimeter) or 15 inch (38 centimeter) monitor, icons are relatively small and hard to differentiate for individuals with limited vision or are ignored by those who have not been shown how to use them.

Graphical user interfaces (GUIs) have evolved over the years. Although the difficulty in using the GUIs has decreased, to individuals not familiar with traditional GUI layouts, performing routine tasks on a computer is difficult. To illustrate, simply opening a file in many applications requires the individual to move the pointer to “File” and click, then move the pointer to “Open” in a pull-down menu and click, and navigate through various directories to find the desired file. For an individual familiar with typical GUIs, this task is rather simple. For an individual not familiar with traditional GUIs, this task can be quite intimidating.

Due to the difficulty in use and intimidation factor, many individuals who could potentially use computers are not using them. Additionally, some users are not using computers to their full extent. To illustrate, some users are only familiar with the GUIs of a few applications, such as only email, and avoid using other applications.

Accordingly, it is desirable to have alternate computer systems to improve use by those untrained or unable to use them.

### SUMMARY

The invention has several aspects. One aspect of the invention is hardware for a easy access computer system. The hardware includes touch screens or touch screen adapters for ease of hardware use. Also, to allow handwriting instead of typing, a graphical tablet is provided. Other aspects of the invention relate to software and their graphical user interfaces (GUIs). The GUIs in one aspect of the invention are limited to a specified number of oversized buttons. The oversized buttons have visible and verbal clues to their use. Preferably, the GUIs do not use scroll bars. Textual information in various applications is turned to audible speech in various software applications. A magnifier button allows for magnification of images on various GUIs. Another aspect of the invention is a search engine which filters web sites based on their easy access.

### BRIEF DESCRIPTION OF THE DRAWING(S)

FIG. 1 is some hardware implementations for an easy access computer system.

FIG. 2 is a “MAIN MENU” GUI.

FIG. 3 illustrates the use of a magnifying glass.

FIG. 4 is a “CORRESPONDENCE” GUI.

FIG. 5 is an “WRITE LETTERS” GUI.

FIG. 6 illustrates an on screen keyboard.

FIG. 7 illustrates the writing pad.

FIG. 8 illustrates hand writing insertion.

FIG. 9 illustrates hand writing to text.

FIG. 10 is a “PREPARE ENVELOPES” GUI.

FIG. 11 is a “SENDAND RECEIVE EMAILS” GUI.

FIG. 12 is a “RECEIVED EMAILS” GUI.

FIG. 13 is a GUI if a received email of FIG. 12.

FIG. 14 is a “SEND EMAIL” GUI.

FIG. 15 is a “SEND AND RECEIVE FAXES” GUI.

FIG. 16 is a “RECEIVED FAXES” GUI.

FIG. 17 is a received fax GUI of FIG. 16.

FIG. 18 is a “SEND FAX” GUI.

FIG. 19 is a “PRINT DOCUMENTS” GUI.

FIG. 20 is a “GO TO INTERNET” GUI.

FIG. 21 is a web browser GUI.

FIG. 22 is a “SEARCH ENGIN/INDEX” GUI.

FIG. 23 illustrates filtering criteria for the search engine/index.

FIG. 24 is a “FILING CABINET” GUI.

FIG. 25 is a “V” folder.

FIG. 26 is a view documents in VA folder screen.

### DETAILED DESCRIPTION OF THE PREFERRED EMBODIMENT(S)

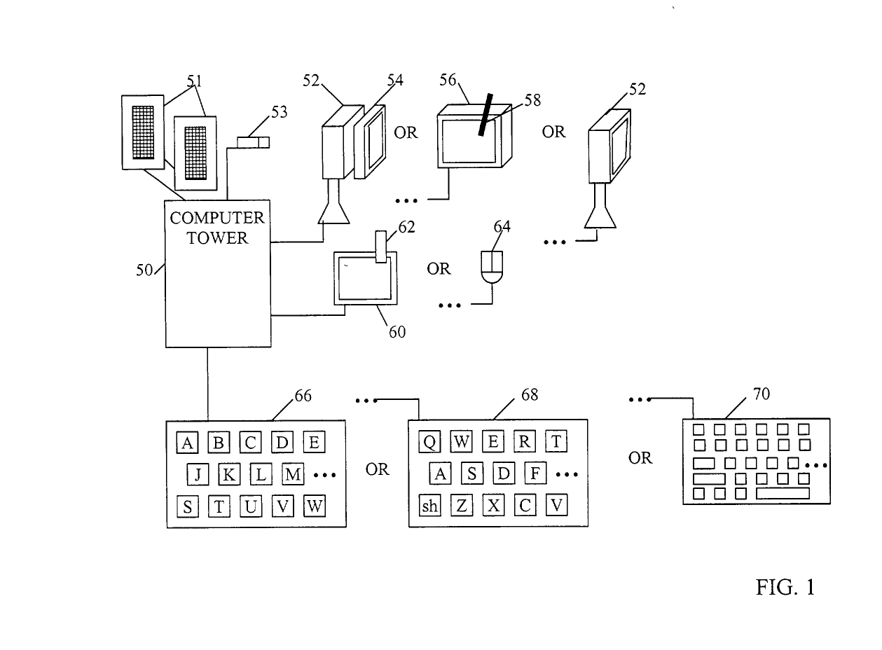

FIG. 1 is a diagram of some implementations of hardware for a easy access computer system. Although the preferred implementation and some alternative implementations of the easy access computer system hardware is described, various combinations of these components and combinations with other hardware components may be used.

The preferred system has a computer tower 50 interfacing with a monitor 52 having a touch screen adapter 54, a graphical tablet 60, speakers 51, microphone 53 and a keyboard 66. The speaker 51 produces sounds, such as for a text to speech application. The microphone 53 is used in voice recognition applications and to record voice messages and songs for emails. The computer tower 50 preferably has, as a minimum, a 1.2 GHz CPU, 256 MB of RAM, a 20 GB hard drive, a 56K flex cable ready modem, a CD ROM, and a floppy disk drive. Although the preferred minimum requirements are desirable to achieve optimum performance of the computer system, lesser components can be used with some potential degradation in performance.

The computer tower 50 interfaces with the monitor 52 with touch screen adapter 54, graphic tablet 60 and “ABCDE” keyboard 66 with oversized keys. Instead of a traditional key ordering, “QWERTY”, the keys on the “ABCDE” keyboard 66 are in alphabetical order. To provide a large display at high resolution, preferably at a minimum, a 19 inch monitor with 1,280 by 1,024 resolution and 85 Hz refresh is used, although lesser displays may be used with a decrease in the display quality. The preferred monitor 52 provides a higher resolution than lower end monitors to improve the visibility of displayed graphics and text and a high refresh rate to reduce the user's eyestrain. A touch screen adapter 54, such as a MagicTouch™ Screen Adapter, is overlaid on the display screen. A user touches the screen adapter 54 and a corresponding location on the overlaid monitor 52 is treated as being touched.

Alternate display mechanisms are also shown in FIG. 1. A touch screen 56 can be used instead of the combination monitor 52 and touch screen adapter 54. The user touches the screen 56 using a finger or utensil, such as a stylus 58. The preferred hardware implementation uses a touch screen 56 or touch screen adapter 54, since interfacing by touching the screen is more intuitive than mouse/pointer control. Alternately, FIG. 1 shows a traditional monitor 52 without touch screen capability. A traditional monitor 52 can be used with input devices, such as a graphical tablet 60 or mouse 64 and a keyboard 66, 68, 70. Although a tradition monitor 52 and mouse 64 is preferably not used, this arrangement may be used to reduce the cost of the overall system. The graphical tablet 60, preferably, has buttons on the tablet for executing tasks of the user intuitive software.

The graphical tablet 60 is used to control the movement of the cursor or accept handwriting or drawn graphics. The user can move the cursor, create text or graphics by moving a pen, such as a wireless pen 62 as shown in FIG. 1. A preferred graphical table is the Graphire 2 tablet. Alternately, a mouse 64 can be used to control a pointer displayed on a monitor.

The preferred “ABCDE” keyboard 66, as shown in FIG. 1, is a keyboard in an alphabetic key layout. The “ABCDE” keyboard 66 with oversized keys, preferably, has no function or arrow keys. Such keys make the keyboard appear busy and make the keyboard more intimidating and confusing to the user. The oversized keys make the keyboard 66 easier to use for users with lesser manual dexterity and friendlier to the less experienced user.

Alternately, also shown in FIG. 1, a keyboard 68 with oversized keys ordered as a traditional keyboard, “QWERTY” keyboard, may be used. Also, a traditional keyboard 70 with normal sized keys, as shown in FIG. 1, may be used. The type of keyboard used is typically based on the individual user's level of sophistication and comfort. A retired secretary may prefer a traditional keyboard 70. An individual with no typing experience may prefer the oversized “ABCDE” keyboard 66. Additionally, with the use of the graphical tablet 60 and a touch screen 54, 56, a keyboard may not be used at all in some hardware implementations.

The easy access GUI and software applications are described primarily in conjunction with the preferred hardware implementations of FIG. 1, although the easy access GUI and software is readily used with alternative hardware implementations.

The software preferably runs on a Windows® operating system, such as Windows XP®, although other operating systems may be used. The software preferably uses many existing software applications, such as word processing and email. These applications are preferably modified by overlaying a new GUI. The preferred overlay obscures the traditional Windows launch bar.

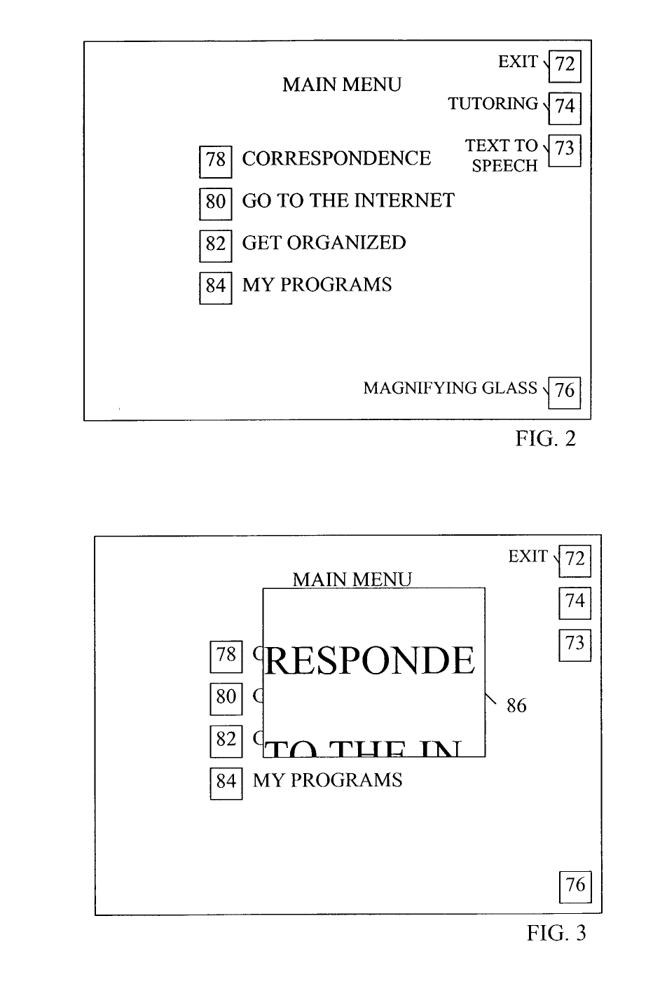

When the system is started, after booting up, the traditional GUIs, such as Windows® start-up screens, are all by-passed. The first non-booting related screen is a screen of the easy access GUI, as illustrated in FIG. 2. The GUIs and screens shown in the drawings are for illustrative purposes and many variants upon these screens may be used.

The preferred GUI, as illustrated in FIG. 2, utilizes oversized buttons, such as at a minimum 60 by 60 pixels in size. The oversized buttons allow for a user to execute the buttons using a finger, if a touch screen is used. The oversized buttons also ease visibility of the buttons. If a mouse or graphical tablet is used to interface with the GUI, a user can more easily move the pointer over the oversized buttons.

The preferred GUI does not have scroll bars. The menus obscure and prevent access to the scroll bars. Scroll bars are difficult to see for users with limited vision. Additionally, individuals with reduced dexterity have difficulty using the scroll bars. To illustrate, a user may accidentally activate an application in the launch bar at the bottom of a traditional Windows® operating system, when attempting to use a horizontal scroll bar near the bottom of the screen. As a result, the preferred GUI attempts to display all the graphics on a single screen or divide them over multiple screens and not utilize scroll bars. Furthermore, the menus also obscure the Window's launch bar so that software applications are not inadvertently launched.

The number of buttons on each screen is preferably reduced, such as to 16 or below, to make the screen less busy and intimidating to a system user. As shown in FIG. 2, only eight (8) buttons are on the GUI (four (4) menu buttons and four (4) non-menu buttons). These buttons preferably execute on a single touch for touch screens 54, 56 or a single click for a mouse 64 or graphical tablet 60. Double clicking is avoided, as being confusing or due to the increased level of manual dexterity required to execute such an operation. Although not shown in the figure, all of the buttons, preferably, have a graphic representing a task, menu or application associated with the button. To illustrate, the “CORRESPONDENCE” button 78 may have an image of a paper and pen on it. Buttons commonly used on multiple screens, such as “EXIT”, “TUTORIAL”, etc., are also preferably available on the graphical tablet 60. By a single touch of the button on the tablet, that button is executed. Additionally, various buttons can be executed by voice recognition software. The user speaks a button name into the microphone 53 and that button is executed.

The buttons have text and verbal tips to their use. The text tips are preferably displayed as post-it notes. When the finger/stylus/pointer moves near the button, the text tip appears and the verbal tip is recited. The verbal tip is a sound file, such as a WAV file, of an individuals voice describing the function performed by executing the button.

For consistency between the screens and GUIs, the buttons are reused. This allows the user to become familiar faster with new screens. Four buttons appearing on most screens are “EXIT” 72, “TUTORING” 74, “MAGNIFYING GLASS” 76 and “TEXT TO SPEECH” 73. For the “MAIN MENU” screen, the “EXIT” button 72 shuts down the operating system. None of the traditional shutdown choices, such as “Restart” or “Restart in DOS”, are provided to simplify the process. For most other applications, the “EXIT” button 72 exits the application and calls up the “MAIN MENU”. By executing the “TUTORING” button 74, a tutorial, preferably both verbal and text, is provided for the user. The content provided by executing the “TUTORING” button changes from application to application. The “TEXT TO SPEECH” button 73 reads the text displayed of the displayed document or menu using the speakers 51.

To aid in the readability of the screen, the “MAGNIFYING GLASS” button 76 is provided. By executing the “MAGNIFYING GLASS” button 76, a magnifying window 86 appears on the screen, as illustrated in FIG. 3. The magnifying window 86 is moved by either touching the screen or by use of the mouse 64 or graphical tablet 60. The magnifier 86 is turned off by executing the magnifier button 76 again.

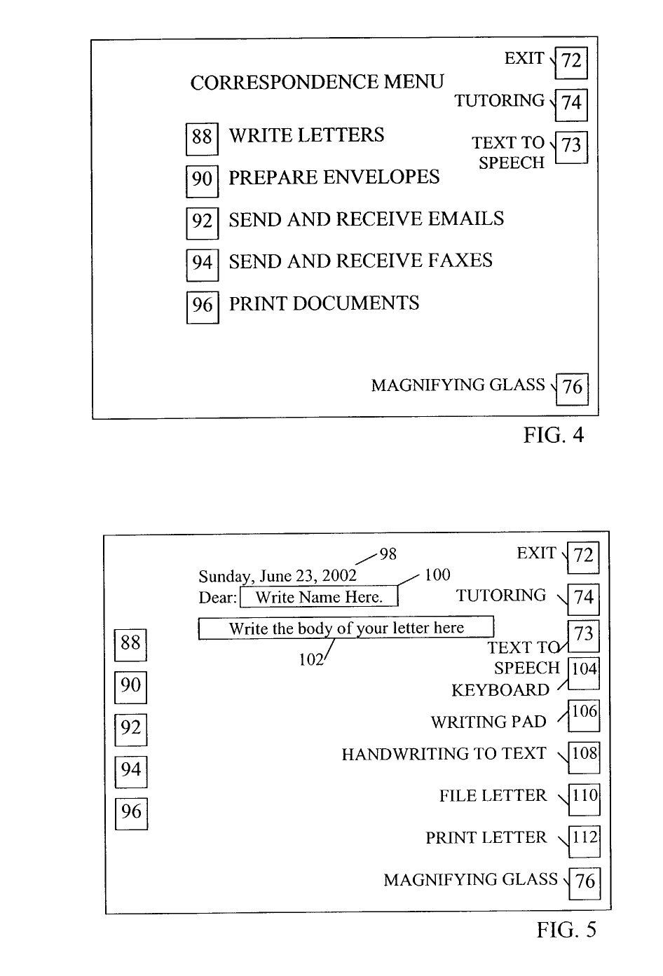

The “MAIN MENU” list, preferably, has four buttons: “CORRESPONDENCE” 78, “GO TO THE INTERNET” 80, “GET ORGANIZED” 82, and “MY PROGRAMS” 84. The “CORRESPONDENCE” button 78 links the user to a screen with a “CORRESPONDENCE” menu as shown in FIG. 4. The “CORRESPONDENCE” menu preferably has five (5) items: “WRITE LETTERS” 88, “PREPARE ENVELOPES” 90, “SEND AND RECEIVE EMAILS” 92, “SEND AND RECEIVE FAXES” 94 and “PRINT DOCUMENTS” 96. The items in the menu are kept at a low number, such as six or less, to reduce confusion. The description of the buttons are, preferably, in every day language, such as simple tasks, for simplicity and to avoid computer jargon.

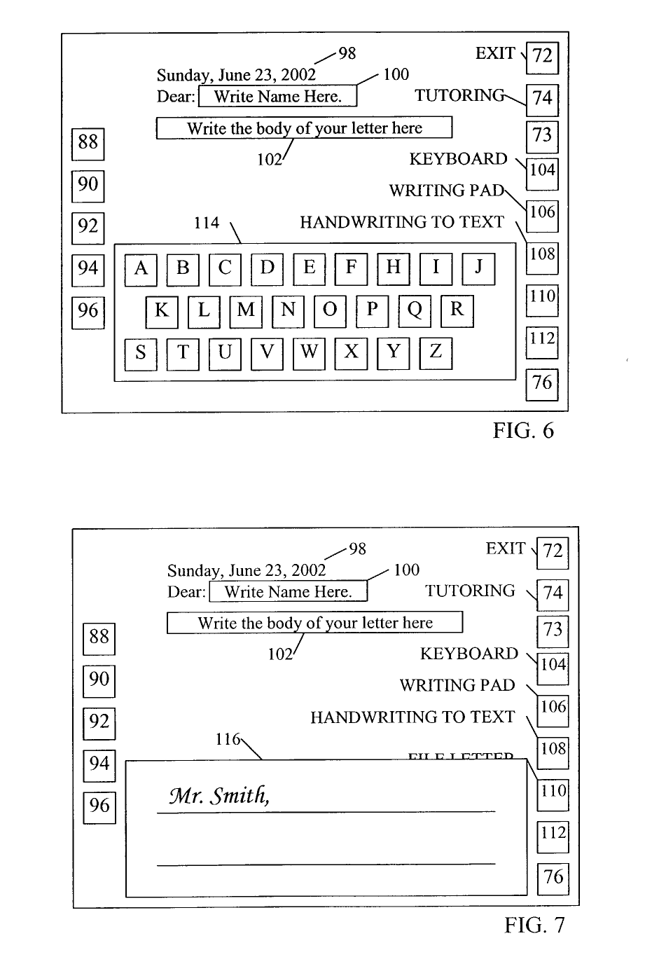

The “WRITE LETTERS” button 88 calls up a word processing application, such as Microsoft Word®, and overlays a easy access GUI over the application as shown in FIG. 5. A template is directly retrieved for a letter. The template has an automatically updated date field 98, a “Dear” line 100 and a “Body” 102. The information to be placed in the blocks is stated in every day language, such as “Write the Body of Your Letter Here”. Text can be input into the letter using the keyboard, a retrieved touch screen keyboard or the graphical tablet 60. The touch screen keyboard 114 is retrieved by pressing a “KEYBOARD” button 104 as shown in FIG. 6. The displayed keyboard 114 is preferably in “ABCDE” format. Using the keyboard, oversized “QWERTY” 68, oversized “ABCDE” 66, traditional 70 or touch screen keyboard 114, text can be typed into the document.

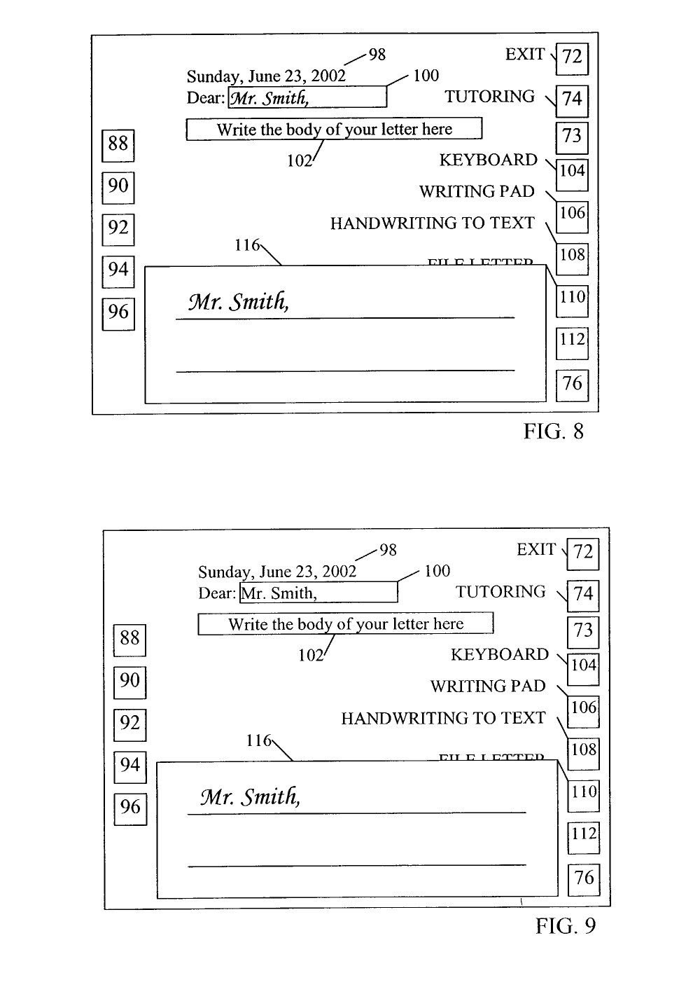

Using the graphical tablet 60 and its associated pen 62, the text of the letter can be handwritten into the document. Using the tablet 60, the user can write text, such as the user's name, as illustrated in FIG. 7. A writing pad 116 is retrieved by pressing a “WRITING PAD” button 106. The written text can be placed in the letter as a graphics file, such as a TIFF, JPG, BMP or GIF as shown in FIG. 8. The graphics file with the handwritten “Mr. Smith” is inserted into the “Dear” line 100. The written text can also be converted to computer text, by executing the “HANDWRITTING TO TEXT” button 108 as shown in FIG. 9. The written “Mr. Smith” is converted in to text and inserted into the “Dear” field 100.

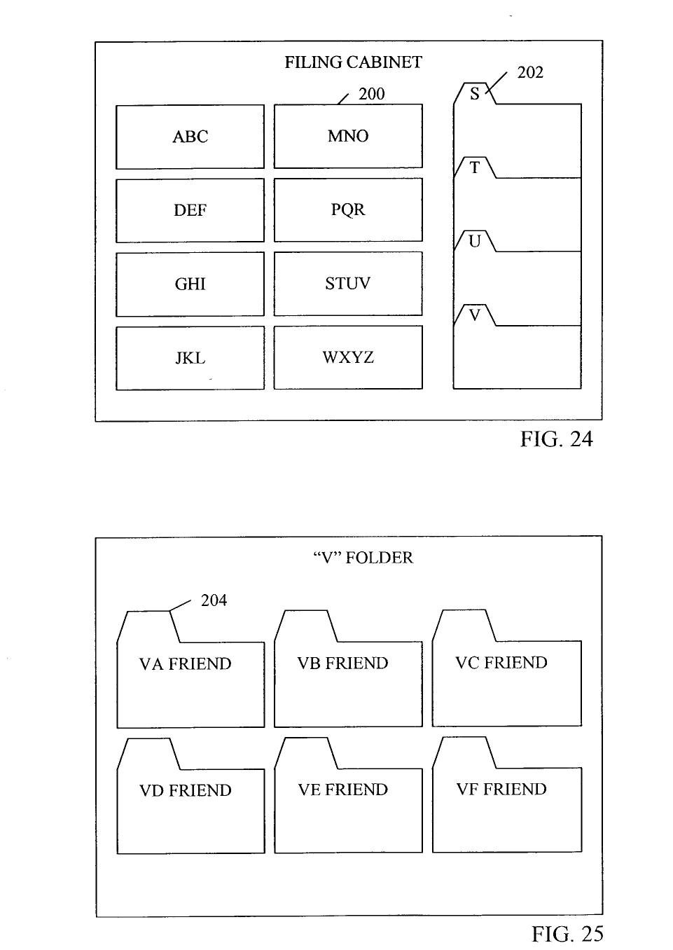

The “WRITE LETTERS” GUI also preferably has a “FILE LETTER” 110, “PRINT LETTER” 112, “EXIT” 72, “TUTORIAL” 74 and “MAGNIFYING GLASS” 76 buttons. The “TUTORIAL” 74 and “MAGNIFYING GLASS” 76 buttons operate in the same fashion as described for FIG. 2, except the “TUTORIAL” button 74 retrieves a tutorial associated with “WRITE A LETTER” application. The “EXIT” button 72 ends the “WRITE A LETTER” session and returns the user to the “MAIN MENU”. The “FILE LETTER” button 110 allows the user to save the letter onto the hard drive and to retrieve documents. The filing and retrieving of documents is explained in more detail in conjunction with FIGS. 24-26. The “PRINT LETTER” 112 button prints the letter. The printing of the letter, preferably, prints the letter directly, without the need of setting up the printer or going to an intermediary printing screen. An advanced print options screen is available and is explained in conjunction with FIG. 19.

The “WRITE LETTER” GUI also has the five “CORRESPONDENCE” menu buttons: “WRITE LETTERS” 88, “PREPARE ENVELOPES” 90, “SEND AND RECEIVE EMAILS” 92, “SEND AND RECEIVE FAXES” 94 and “PRINT DOCUMENTS” 96. Executing one of these buttons jumps to the corresponding application and/or GUI.

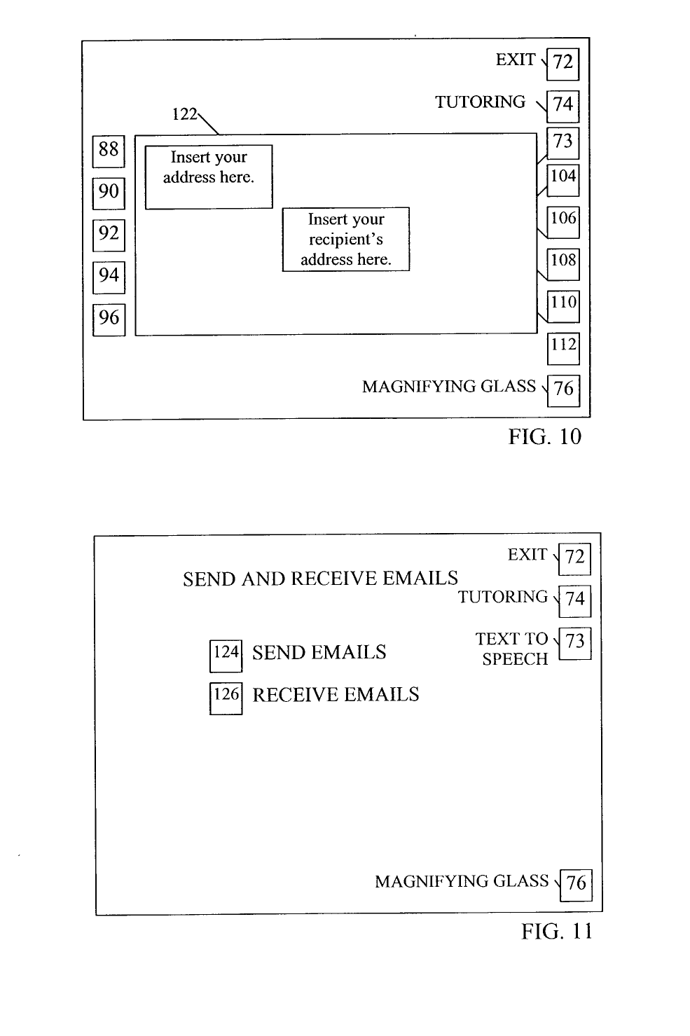

Referring to the “PREPARE ENVELOPES” button 90, after executing the “PREPARE ENVELOPES” button 90, a word processing application with an envelope template 122 is retrieved as illustrated in FIG. 10. The buttons for the “PREPARE ENVELOPES” GUI are similar to the “WRITE LETTERS” GUI. Text is inserted into the letter by handwriting or keyboard. The “PRINT ENVELOPE” button 112 is configure to print the prepared envelope on a standard sized envelope. The “FILE ENVELOPE” button 110 files the envelope for later retrieval.

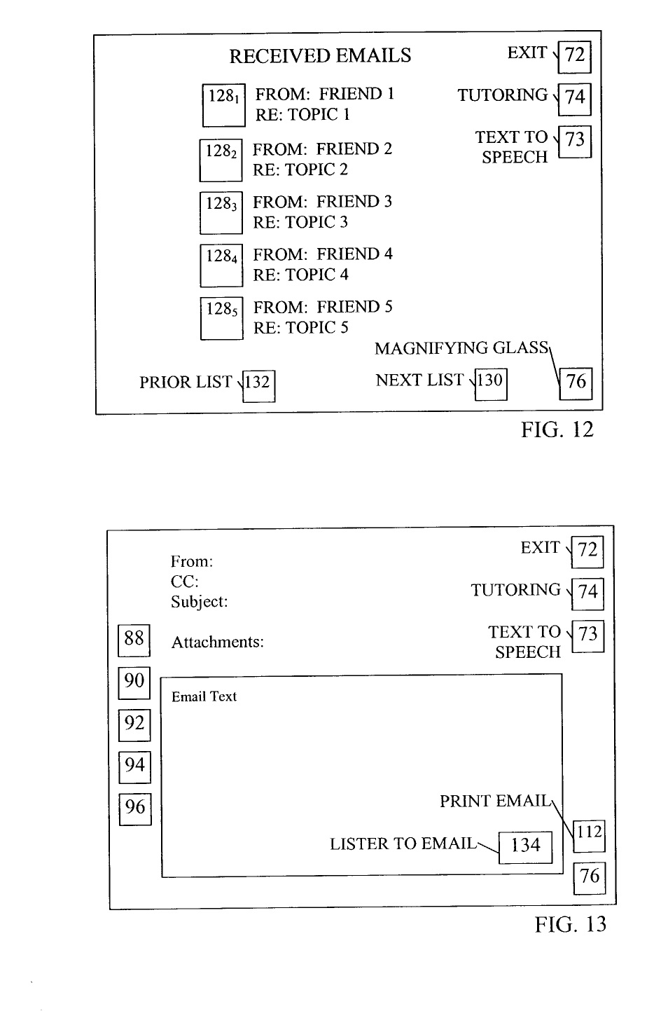

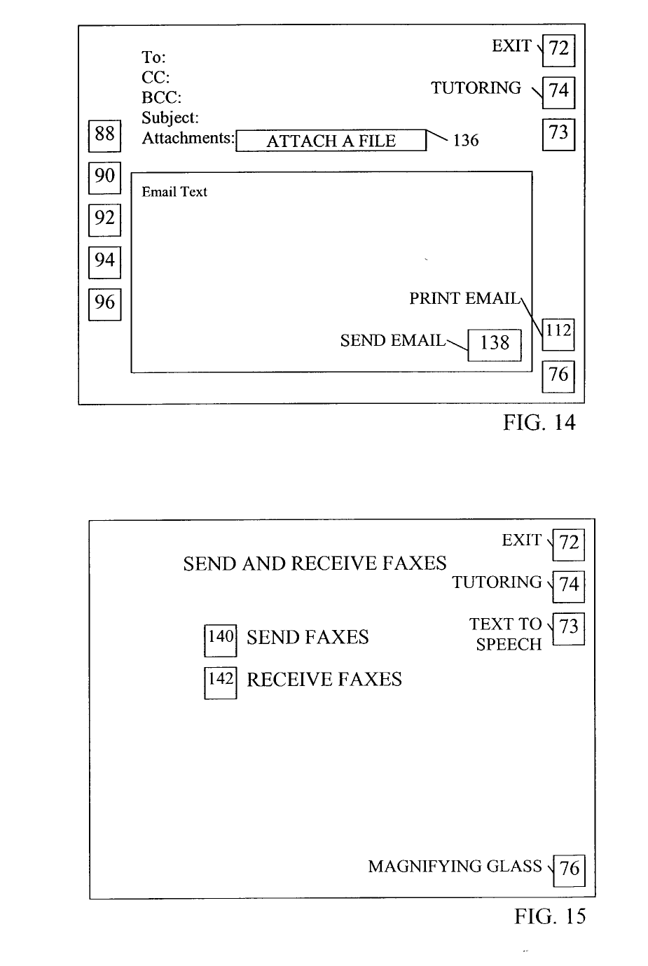

The “SEND AND RECEIVE EMAILS” button 92 calls up a “SEND AND RECEIVE EMAILS” menu as shown in FIG. 11. The “SEND AND RECEIVE EMAILS” menu preferably has two choices: “SEND EMAIL” 124 or “RECEIVE EMAIL” 126. If either button is executed, an email application, such as Outlook®, is called. Overlaid on top of the email application is a easy access GUI. For “RECEIVE EMAIL” 126, emails received by the user are displayed in large text as shown in FIG. 12. A “NEXT LIST” button 130 is pressed to retrieve the next list of emails and to retrieve a prior list, a “PRIOR LIST” button 132 is pressed. To eliminate scrolling and increase font size, only a limited number of received emails are displayed, such as only eight or less. By pressing a button 1281-1285 next to received email, that email is displayed as shown in FIG. 13. Also, as shown in FIG. 13, a “LISTEN TO EMAIL” button 134 may be executed. The “LISTEN TO EMAIL” button 134 calls a text to speech application to read the email.

For “SEND EMAIL” 134, a GUI similar to the “WRITE LETTERS” GUI is displayed per FIG. 15. Text is inserted into the appropriate places in the template by handwriting or keyboard. Attachments are preferably retrieved by pressing an “ATTACH A FILE” button 136. To send the email, the “SEND” button 138 is executed. Additionally, using the microphone 53 voice messages can be attached to emails, such as in a WAV file.

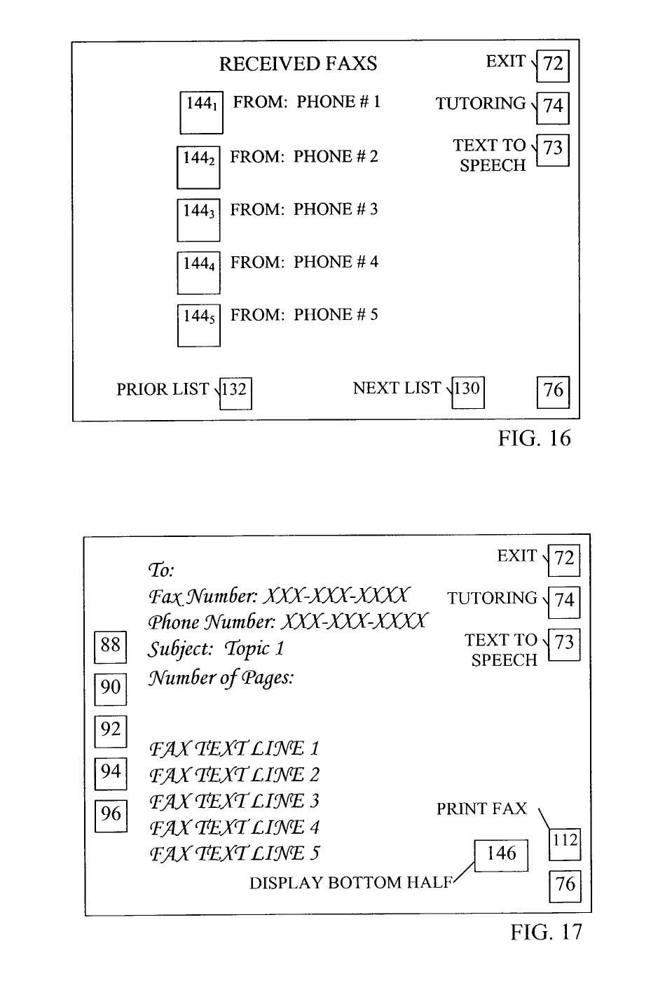

The “SEND OR RECEIVE FAX” button 94 calls up a menu with two buttons: “SEND FAX” 140 and “RECEIVE FAX” 142. When the “RECEIVE FAX” button 142 is executed, a receive fax GUI is displayed as shown in FIG. 16. Besides each received fax is a button 1441-1445 to display the fax. One page of a displayed fax is split over two screens for legibility without scrolling. To display either the top or bottom portion of the fax, a corresponding button is executed, such as “DISPLAY BOTTOM HALF” 146 as shown in FIG. 17.

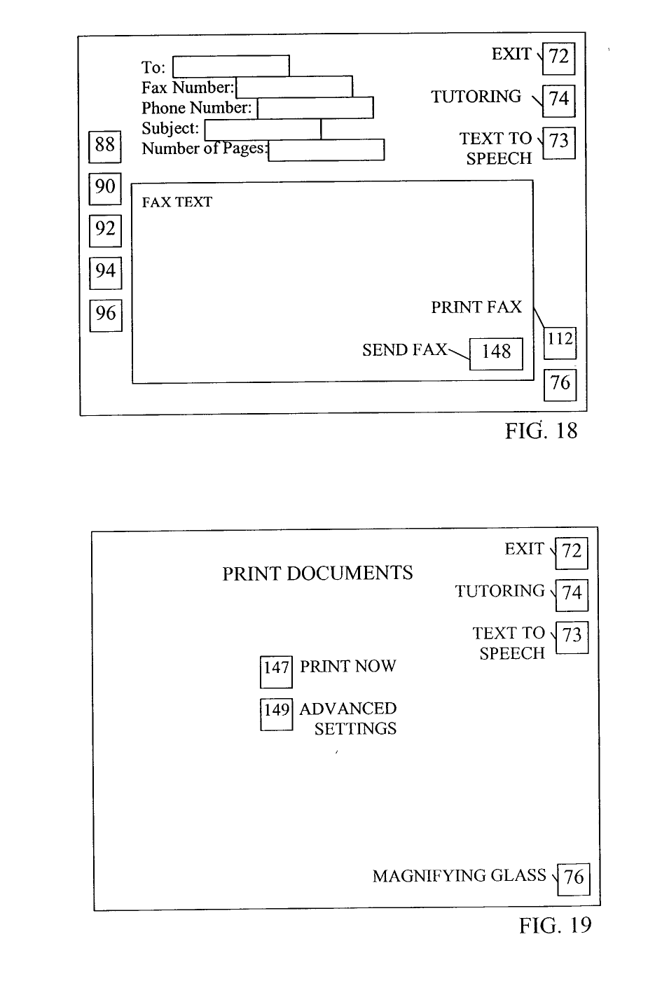

For “SEND FAX”, a GUI similar to the “WRITE LETTERS” GUI is displayed per FIG. 18. Text is inserted into the appropriate places in the template by handwriting or keyboard. To send the fax, the “SEND” button 148 is executed.

The “PRINT DOCUMENTS” button pulls up a menu as shown in FIG. 19. The menu has two buttons: “PRINT NOW” 147 and “ADVANCED SETTINGS” 149. The “PRINT NOW” button 147 prints the document currently in the application using a default print template for the application. For the “ADVANCED SETTINGS” button 149, a new menu is retrieved having advanced settings for the printer.

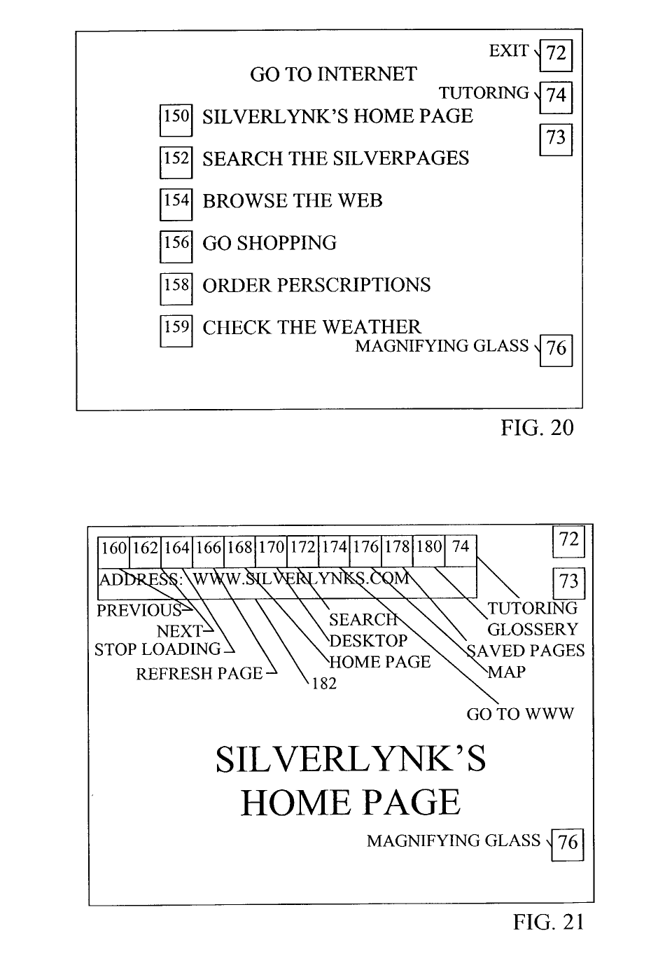

Referring to FIG. 20, executing the “GO TO THE INTERNET” button takes the user to the “GO TO THE INTERNET” menu. As shown in FIG. 20, the menu in the preferred implementation has six (6) menu buttons: “SILVERLYNK'S HOME PAGE” 150, “SEARCH THE SILVERPAGES” 152, “BROWSE THE WEB” 154, “GO SHOPPING” 155, “ORDER PERSCRIPTIONS” 158 and “CHECK THE WEATHER” 159. Executing the “SILVERLYNK'S HOME PAGE” button 150 operates the browser and directly opens up the Silverlynk's web site. Executing the “SEARCH THE SILVERPAGES” button opens a search engine/index, which is described in more detail in conjunction with the Internet browser.

When the “BROWSE THE WEB” button 154 is executed, an Internet browser, such as Internet Explorer®, with an easy access overlay is started. After a user executes the “GO TO WWW” button 154, an address field as shown in FIG. 21 is displayed. Prior to executing that button, the address field is not present on the GUI. The web address field displays the address of the current web page as is common for browsers The text in the address field 182 is preferably larger than normal, being at least a 16 pt. font to ease readability. The overlay has a limited number of oversized buttons. The buttons correspond to typical browsing type commands: “PREVIOUS” 160, “NEXT” 162, “STOP LOADING” 164, “REFRESH PAGE” 166, “HOME PAGE” 168, “EXIT” 170, “SEARCH” 172, “GO TO WWW” 174, “MAP” (history) 176, “SAVED PAGES” (favorites) 178 and “TUTORING” (help) 74. The “GLOSSARY” 180 pulls up a list explaining Internet terms in plain language to aid the user in browsing. These buttons operate primarily as in traditional browsers. However, the “SEARCH” button 170 links to an easy access search index/engine.

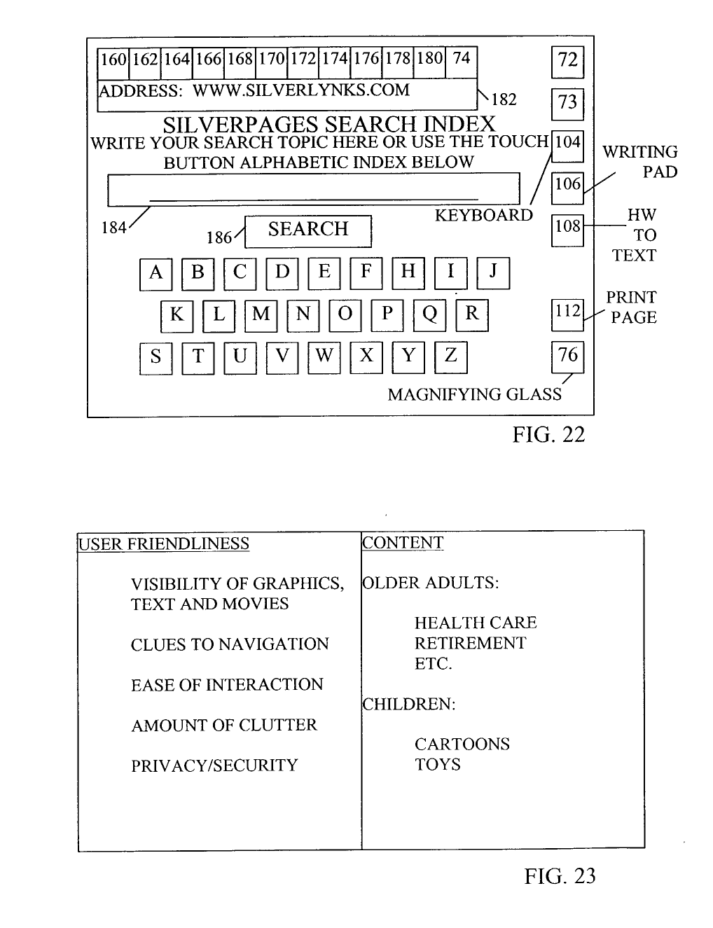

By executing the “SEARCH” or the “SEACH THE SILVERPAGES” button, a preferred search page of the search index/engine is shown, as in FIG. 22. The preferred search page has an input field 184 to allow for a user to input search criteria. The search page also has alphabetic keys, A-Z, on the page to allow the user to jump to a page having topics corresponding to each letter. To start searching, the “SEARCH” button 186 is executed. To alleviate the need for scroll bars, each topics page is configured to be fully displayed on the screen.

Search criteria can be input into the search criteria field, by keyboard or through hand writing. The “WRITING PAD” 106 and “HANDWRITTING TO TEXT” 108 button allows for handwritten text to be input into the search criteria field. The “KEYBOARD” button 104 allows for touch screen keyboard input into the search criteria field. Also, by keyboard or handwriting, a web address, such as www.silverlynk.com, can also be input into the web address field 182 so that the web page of that address is retrieved and displayed.

The preferred search engine/index preferably filters the web sites based on their user friendliness and content as shown in FIG. 23. Criteria for evaluating the web sites for user friendliness 188 include the visibility of graphics, text and movies; clues as to navigation of the web site, ease of interaction with the web site, amount of clutter and level of privacy/security. The content 190 of the web sites is also filtered based on the targeted users of the easy access web site. For older adults, content relating to their interests, such as health care, retirement, etc., would be preferred. For children, topics, such as cartoons and toys, would be preferred.

The preferred filtering approach would be a quantitative approach. Each web site would be evaluated based on specified criteria and given a score. A ranking is attributed to each web site based on its score. Separate rankings may be provided for both content and user friendliness. The preferred ranking combines both the content and user friendliness scores. Additionally, sites receiving a score below a certain threshold for either content, user friendliness or both may be eliminated from the list of searchable web sites.

The following is a preferred scoring algorithm for user friendliness, although other approaches may be used. An overall high score indicates a more easy access web site. An overall low score indicates a less easy access web site. The preferred easy access criteria includes: font size, button size, visual clues, captioning, picture size, movie display area, auditory clues, screen tips, privacy statements, security certificates and the presence of frames, banner ads and pop-up windows.

Web pages having a large font size are desirable. Table 1 is a change in score based on the weighted average font size of a web page. The weighted average may be a true weighted average or may further penalize fonts at the lower values, such as 6-8 pts. To illustrate, a web site with 1000 6 pt. fonts and 1000 23+ pt. fonts may rate as an average 11 pt. instead of its true average of approximately 14.5 pt.

TABLE 1

| Average Font Size | | Change in Score |
|---|---|---|
| 6-8 | pts. | −6 |
| 9-10 | pts. | −4 |
| 11-12 | pts. | −2 |
| 13-14 | pts. | 0 |
| 15-16 | pts. | +2 |
| 17-18 | pts. | +4 |
| 19-20 | pts. | +6 |
| 21-22 | pts. | +8 |
| 23+ | pts. | +10 |

Web sites with large buttons are easier to use than sites with small buttons. Table 2 is a preferred change in score based on the average area of buttons in pixels.

TABLE 2

| Average Pixel Area | Change in Score |
|---|---|
| 0-1900 | −2 |
| 2000-2499 | 0 |
| 2500+ | +2 |

It is also desirable to have visible clues, such as post-it type clues, and captioning for the buttons. Preferably, for each button having a visual clue, a +1 is added to the ranking and, for each captioned button, a +1 is added to the ranking.

For visually limited individuals, it is desirable to have pictures, such as JPG, BMP, GIF files, as large as possible. Table 3 is a preferred change in scoring based on the average area in number of pixels.

TABLE 3

| Average Pixel Area | Change in Score |
|---|---|
| 0-9999 | −2 |
| 10000-39999 | 0 |
| 40000+ | +2 |

Likewise, it is desirable to have movies, such as AVI, MOV and MPEG files, with larger viewing areas. Table 4 is a change in score by average area in pixels of the movie images.

TABLE 4

| Average Pixel Area | Change in Score |
|---|---|
| 0-9999 | −2 |
| 10000-39999 | 0 |
| 40000+ | +2 |

Since the size of adjustable movie images can be increase, a +2 change to the score is provided for adjustable sized movies.

Auditory clues add to the ease of using a web site for users having limited vision. For each auditory clue, a +1 is added to the score. Web sites providing tips for using the web site are preferred. For each visible tip, a +1 is added to the web sites rating and, for each auditory tip, a +2 is added to the rating.

Certain features of web sites, such as banner ads, frames and pop-up windows, clutter a web site and make it more difficult to navigate. Sites having these features are penalized as illustrated in Tables 5-7.

TABLE 5

| Frames | Change in Score |
|---|---|
| No Frames | +4 |
| 1-2 Frames | 0 |
| 3+ Frames | −4 |

TABLE 6

| Banner Ads | Change in Score |
|---|---|
| No Ads | +4 |
| 1 Ad | 0 |
| 2+ Ads | −4 |

TABLE 7

| Pop-up Windows | Change in Score |
|---|---|
| No Pop-ups | +4 |
| 1+ Pop-ups | 0 |
| 2+ Pop-ups | −4 |

Privacy and security are desirable for a web site. Sites have a Platform for Privacy Preferences (P3P) privacy policy are preferred, a +4. Sites having security certificates, verifying the identity of the individuals running the web site or verifying the security of the web site, are preferred, a +4.

The content of the web site can also be quantitatively evaluated. The preferred approach checks the web sites for key words and utilizes other content rating sources to evaluate the sites. A preferred evaluation algorithm for older adults is as follows. Sites having key words per Table 8 are given a +1.

TABLE 8

| Senior | Senior Citizens | Senior Organizations |
|---|---|---|
| Elders | Retired | Retirement |
| Retirement Fund | AARP | NIA |
| Aged | Middle Aged | Grandmother |
| Grandfather | Grandchildren | Assisted Living |
| Eldercare | Nursing Homes | Pensions |
| Pensioners | National Institute on Aging | Association of American |
| | | Retired Persons |
| Pension Benefits | Health Care | Social Security |

A preferred content rating source is the SafeSurf Internet Rating Standard. For sites not rated by this standard, a −9 is subtracted from the rating. For rated sites, a 0 to −9 rating is provided.

Referring to FIG. 21, executing the “GO SHOPPING” button 156 operates the browser and opens a web site containing links to shopping web sites. The “ORDER PRESCRIPTIONS” button 158 operates the browser and opens a prescription ordering web site. The “CHECK THE WEATHER” button 159 opens a weather web site.

Referring to FIG. 2, executing the “GET ORGANIZED” button displays a “GET ORGANIZED” menu, as shown in FIG. 2. The get organized menu includes “ADDRESS BOOK”, “NOTES AND REMINDERS”, “SHOPPING LISTS”, and “FILING” buttons. By executing the “ADDRESS BOOK” or “NOTES AND REMINDERS” buttons, a corresponding section of an organizational software program, such as Outlook® with an easy access overlay, similar to FIG. 5, is operated. The “ADDRESS BOOK” button links to the address book of the organizational software and the “NOTES AND REMINDERS” button links to a “to do” list of the organizational software. Executing the “SHOPPING LISTS” button operates a shopping list template of a word processing software program, which has an easy access GUI.

The “FILING” buttons takes user to a “FILING CABINET” menu as shown in FIG. 24. To be intuitive to individuals not familiar with computer GUIs, the file management system is structured like a filing cabinet. The filing cabinet is arranged in alphabetical order with drawers 200 having 3-4 letters of the alphabet in them. When a drawer is executed, the folders 202 in the drawer are shown. To illustrate using FIG. 24, when the “STUV” drawer 200 is executed, folders 202 “S”, “T”, “U” and “V” are shown. By executing one of the folders 202, a folder screen as shown in FIG. 25 is displayed.

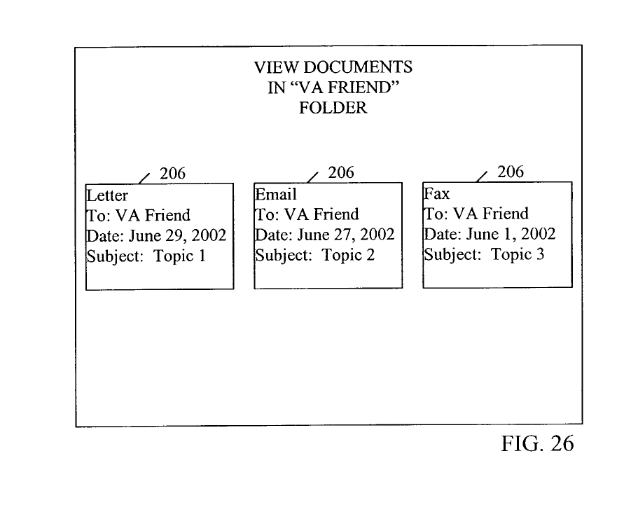

The folder screen has a folder 204 as defined by the user. One folder 204 can be for a friend or a folder 202 can be for a topic. As shown in FIG. 25, each folder 204 is for a particular friend. By executing a user defined folder, documents of that folder in summary are displayed per FIG. 26. The information displayed in the summaries includes: the type of document (letter, fax or Email), to and from information, date of the document and the subject. By executing a summary 206 of document, a corresponding software application executes and displays the document.

Referring to FIG. 2, when the “MY PROGRAMS” button is executed, a menu of traditional software programs, such as “Solitaire” and “Excel”, are listed. These programs are provided in an easy access menu and are started by pressing a button associated with the program. The execution buttons for these programs are, preferably, the 60 by 60 pixel minimum in size. When the user loads a traditional software application, the easy access software generates the large execution button on descriptive caption and clues for the application.

What is claimed is:

1. A method for evaluating web sites, the method comprising:
providing web sites for evaluation;
determining for each web site sizes of text and graphics;
determining a score of each web site using the determined sizes, for web sites having larger sizes a better score is given; and
ranking each web site using the determined score.

2. The method of claim 1 wherein the size of text is evaluated by taking a weighted average of font sizes in each web site.

3. The method of claim 1 further comprising increasing a score for a web site, if that web site has clues to navigating, the clues including text and auditory clues.

4. The method of claim 1 further comprising decreasing a score for a web site, if the web site has clutter, clutter including banner ads, frames and pop-up windows.

5. An email application having a graphical user interface comprising:
a displayed image of information associated with an email, the displayed image having fields for accepting email information;
a handwriting button enabling input of handwriting from a user through a graphical tablet;
entering the inputted handwriting into the email information fields; and
sending an email with the inputted handwriting.

6. The email application of claim 5 wherein the inputted handwriting is inputted as graphic information.

7. The email application of claim 5 further comprising converting the inputted handwriting into computer text; wherein the inputted handwriting is the converted computer text of the inputted handwriting.

8. The email application of claim 5 further comprising converting voice signals from a microphone into an audio file and attaching the audio file to an email.

9. A software application having a plurality of graphical user interfaces GUIs, the software application comprising:
each GUI comprising:
a plurality of buttons, a substantial number of the buttons being at least 60 by 60 pixels in size and having text and verbal clues, none of the buttons executing by double clicking; and
a substantial number of the GUIs not having scroll bars and a maximum number of sixteen buttons on those GUIs.

10. The software application of claim 9 wherein the GUIs obscuring the scroll bars of underlying applications.

11. The software application of claim 9 wherein the software application runs on a windows operating system and the GUIs obscuring a launch bar of the windows operating system.

12. The software application of claim 9 wherein the software application is used by older adults.

13. The software application of claim 9 wherein the software application is used by infirmed individuals.

14. A computer system for use in text applications, the computer system comprising:
a touch screen for displaying a graphical user interface (GUI) of a text application, the GUI having three buttons: a first button for displaying a touchable screen keyboard allowing a user to input text into the text application by touching keys of the touchable screen keyboard, a second button for displaying a handwriting input from a graphical tablet and a third button for converting the displayed handwriting into computer text for input into the text application; and
the graphical tablet for inputting handwriting by a computer system user.

15. The computer system of claim 14 wherein the handwriting input is input into the text application as a graphical file.

16. The computer system of claim 14 wherein the touch screen is a monitor and a touch screen adapter.

17. The computer system of claim 14 wherein the touch screen is a display screen which receives input by touching the display screen.

18. The computer system of claim 14 further comprising a microphone for accepting voice input to execute buttons of the GUI.

19. The computer system of claim 14 further comprising a microphone for accepting a voice message input to be attached to an email.

20. The computer system of claim 14 further comprising speakers for producing voice signals of a text to speech application converting text of the GUI into speech.
